(19) United States
(12) Patent Application Publication
(10) Pub. No.: US 2016/0335896 A1
(43) Pub. Date: Nov. 17, 2016

(54) Vehicle Finder

(71) Applicants: DENSO International America, Inc., Southfield, MI (US); DENSO Corporation, Kariya-Shi (JP)

(72) Inventor: Reiji IWAMOTO, West Bloomfield, MI (US)

(21) Appl. No.: 14/712,347

(22) Filed: May 14, 2015

(51) Int. Cl. G08G 1/127

(52) U.S. Cl. CPC G08G 1/127

(57) ABSTRACT

A system for guiding a person to a vehicle. The system includes a vehicle control unit configured to generate vehicle position data identifying the vehicle's location and transmit the vehicle position data with a transmitter. The system further includes a vehicle smart key including a smart key receiver, a smart key storage unit, and a smart key transmitter. The smart key receiver is configured to receive the vehicle position data transmitted by the vehicle control unit. The smart key storage unit is configured to store the vehicle position data. The smart key transmitter is configured to transmit the vehicle position data to a smart device for display of the vehicle's location on the smart device.

### FIELD

The present disclosure relates to systems and methods for directing a person back to their vehicle after they have parked and left their vehicle.

### BACKGROUND

This section provides background information related to the present disclosure, which is not necessarily prior art.

It is not uncommon for a person to forget exactly where they parked their vehicle, particularly when the vehicle is left for an extended period of time and/or parked in a large parking lot, such as at a shopping center or at an airport. It would therefore be desirable for a person to have a vehicle finder according to the present teachings that will help the person locate their vehicle and direct the person back to their vehicle.

### SUMMARY

This section provides a general summary of the disclosure, and is not a comprehensive disclosure of its full scope or all of its features.

The present teachings provide for a system for guiding a person to a vehicle. The system includes a vehicle control unit configured to generate vehicle position data identifying the vehicle's location and transmit the vehicle position data with a transmitter. The system further includes a vehicle smart key including a smart key receiver, a smart key storage unit, and a smart key transmitter. The smart key receiver is configured to receive the vehicle position data transmitted by the vehicle control unit. The smart key storage unit is configured to store the vehicle position data. The smart key transmitter is configured to transmit the vehicle position data to a smart device for display of the vehicle's location on the smart device.

The present teachings also provide for a system for guiding a person to a vehicle including a receiver and a vehicle control unit. The vehicle control unit is configured to generate map coordinates corresponding the vehicle's location based on global positioning system (GPS) signals received from the receiver, and generate a uniform resource locator (URL) to an Internet mapping website that includes the map coordinates corresponding to the vehicle's location. The vehicle smart key is configured to receive the URL transmitted from the vehicle control unit, store the URL at the smart key, and transmit the URL to a smart device. The URL directs the smart device to a map identifying the vehicle's location.

The present teachings also provide for a method for guiding a person to a vehicle. The method includes generating vehicle location information corresponding to the vehicle's location using a vehicle control unit and storing the vehicle location information at the vehicle control unit; generating at the vehicle control unit a uniform resource locator (URL) including map coordinates based on the vehicle location information, the map coordinates corresponding to the vehicle's location; and transmitting the URL to a vehicle smart key at vehicle shut down. Upon transmission of the URL to a smart device, the smart device will display the vehicle's location and guide the person to the vehicle.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates a vehicle finder system according to the present teachings; and

FIG. 2 illustrates a method according to the present teachings for directing a user to their vehicle.

Corresponding reference numerals indicate corresponding parts throughout the several views of the drawings.

### DETAILED DESCRIPTION

Example embodiments will now be described more fully with reference to the accompanying drawings.

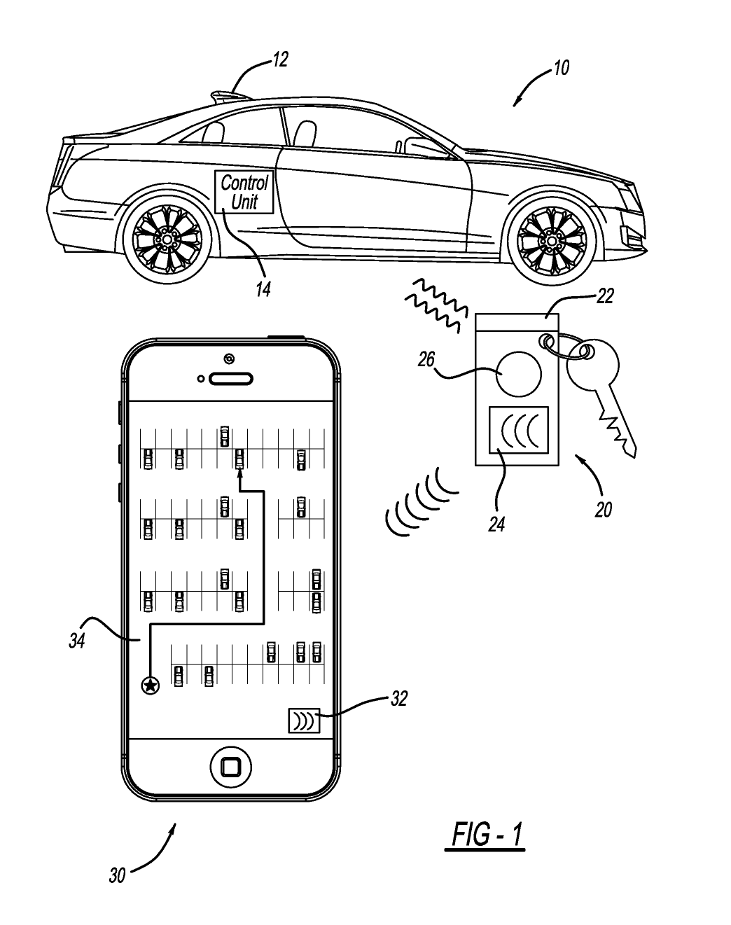

With initial reference to FIG. 1, a system for guiding a person to a vehicle, such as their own vehicle after parking and leaving their vehicle, is illustrated. The system generally includes a vehicle 10, a vehicle smart key 20, and a smart device 30. The vehicle 10 can be any suitable vehicle, such as a car, truck, sport utility vehicle (SUV), military vehicle, bus, motorcycle, aircraft, etc.

The vehicle 10 generally includes a transmitter/receiver 12 and a control unit 14. The transmitter/receiver 12 is any suitable device configured to transmit and receive signals, such as radio frequency (RF) signals, transmitted using any suitable transmission protocol. For example, the transmitter/receiver 12 is configured to receive signals transmitted from satellites, such as global positioning system (GPS) signals, and signals transmitted from ground based transmitters. The transmitter/receiver 12 is further configured to transmit signals, such as RF signals, to the vehicle smart key 20 using any suitable transmission protocol. For example, the transmitter/receiver 12 is configured to transmit vehicle position data identifying the location of the vehicle 10 to the vehicle smart key 20.

The control unit 14 is any suitable vehicle control unit configured to generate vehicle position data identifying the location of the vehicle 10 based on inputs to the control unit 14. The vehicle position data can be any suitable data that identifies the location of the vehicle 10. For example, the vehicle position data can include map coordinates, such as map coordinates derived by the control unit 14 from the GPS signals received by the transmitter/receiver 12 and input to the control unit 14. The control unit 14 can thus include a GPS receiver.

The vehicle position data can include any information identifying the location of the vehicle 10 in addition to, or in place of, GPS coordinates. Thus if reliable GPS coordinates are not available, the control unit 14 is configured to derive the location of the vehicle 10 in any other suitable manner. For example, the control unit 14 is configured to generate the vehicle position data from signals received by the transmitter/receiver 12 from ground-based transmission towers, such as cell towers. Based on the relative strength of signals received from multiple ground-based towers, the control unit 14 is configured to determine the position of the vehicle 10 relative to the towers, such as by triangulation. The control unit 14 is further configured to derive position of the vehicle 10 based on data from a local area network (LAN) of the vehicle 10. For example, it is becoming increasingly common to outfit vehicles with wireless LAN Wi-Fi networks. Such LAN networks transmit and receive wireless data to and from ground based towers and/or satellites. The location of the vehicle 10 can be determined based on the vehicle's relative location to the ground based towers (such as by using triangulation) and/or the satellites, such as based on GPS signals received from the satellites.

The control unit 14 is further configured to generate the vehicle position data based on various vehicle operating parameters, such as vehicle speed, vehicle heading, and historical vehicle steering information. Thus when the vehicle 10 is operating in an area where the vehicle 10 is unable to receive wireless signals, such as when the vehicle 10 is underground, within a covered parking deck, in a tunnel, in a mountainous area, or any area where GPS signals are obstructed, the control unit 14 can identify the location of the vehicle 10 based on such operating parameters representing movement of the vehicle subsequent to loss of GPS signals or other wireless signals. Based on this movement, the location of the vehicle 10, or an estimate thereof, can be determined.

The control unit 14 is further configured to generate a uniform resource locater (URL), and can configure the vehicle position data in the form of a URL. The URL can be an Internet URL to any suitable Internet mapping website, such as Google Maps or Apple Maps for example, including map coordinates generated by the control unit 14 that identify the location of the vehicle 10.

The control unit 14 is configured to transmit the vehicle position data to the vehicle smart key 20 using the transmitter/receiver 12. The vehicle position data can be transmitted to the vehicle smart key 20 in any suitable manner using any suitable transmission protocol. For example, the vehicle position data can be transmitted using any suitable low frequency transmission protocol. The control unit 14 is configured to generate and store the vehicle position data at predetermined intervals, such that the most recently stored vehicle position data replaces previously stored vehicle position data, for example. Thus, when the vehicle 10 is turned off, the control unit 14 transmits the most recently stored vehicle position data to the smart key 20.

The control unit 14 can further include passive entry/passive start (PEPS) capabilities for wirelessly unlocking the vehicle 10 and allowing a person in possession of a wireless key, such as the wireless vehicle smart key 20, to start the vehicle without inserting a physical key into an ignition.

The vehicle smart key 20 generally includes a receiver 22, a transmitter 24, and a button 26, and can include PEPS capabilities allowing a user to passively unlock the vehicle 10 and start the vehicle 10 without inserting a physical key in the ignition. The receiver 22 can be any suitable receiver configured to receive the vehicle position data transmitted from the vehicle 10, such as in the form of a URL. The receiver 22 can be any suitable low frequency signal receiver, for example. The transmitter 24 can be any suitable transmitter, such as a near field communication transmitter configured to transmit the vehicle position data, such as in the form of a URL, to the smart device 30 when the vehicle smart key 20 is brought into contact with, or within close proximity of, the smart device 30. The button 26 can be assigned any suitable functionality, such as remote engine start functionality, door lock/unlock functionality, or can be a panic button that sounds a horn of the vehicle 10 when pressed.

The smart device 30 can be any suitable smart device, such as a mobile smart phone, a tablet computer, a smart watch, smart glasses, or any other suitable mobile computing device. The smart device 30 generally includes a receiver 32 and a display 34. The receiver 32 can be any suitable receiver, such as a near field communication receiver (NFC). The receiver 32 can be configured to receive the vehicle position data transmitted from the vehicle smart key 20 by way of the transmitter 24 when the vehicle smart key 20 is brought into contact with, or within close proximity of, the smart device 30. Upon receipt of the vehicle position data, the smart device 30 is configured to display the location of the vehicle 10 on the display 34 using any suitable mapping software, such as Google Maps or Apple Maps. When the vehicle position data includes the Internet URL to a mapping website, the smart device 30 can be configured to navigate to the particular Internet mapping website of the URL and display map coordinates contained within the URL corresponding to the location of the vehicle 10.

The smart device 30 is further configured to identify its own location using GPS, cell tower triangulation, or any other suitable technique. The smart device 30 can then use any suitable mapping software or website (as directed by the URL for example) to map a route from the current location of the smart device 30 (and thus the current location of the user of the smart device 30) to the vehicle 10, as generally illustrated in FIG. 1 on the display 34 of the smart device 30. In this manner, the present teachings provide for a system for guiding a person back to their vehicle 10 using the smart device 30.

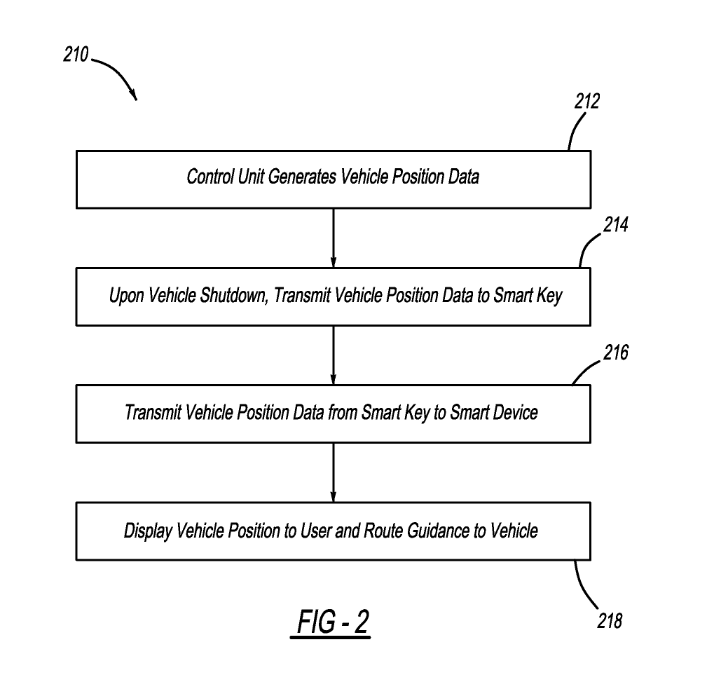

With continued reference to FIG. 1, and additional reference to FIG. 2, a system for guiding a person to the vehicle 10 is illustrated in FIG. 2 at reference numeral 210. At block 212, the control unit 14 generates the vehicle position data as described above, which can be stored to replace previously stored vehicle position data. The control unit 14 can update the vehicle position data at any suitable time interval, and/or may be configured to automatically update the vehicle position data when the vehicle 10 is shut down. Historical vehicle position data can be retained at the control unit 14 or can be replaced each time that more up-to-date vehicle position data is generated by the control unit 14.

With reference to block 214, when the vehicle 10 is shut down, the control unit 14 is configured to transmit the most recent vehicle position data to the smart key 20 using the transmitter/receiver 12. The vehicle smart key 20 receives the vehicle position data with the receiver 22 and stores the vehicle position data at the smart key, such as in a manner that the vehicle position data replaces any previously stored vehicle position data. The vehicle smart key 20 now has the vehicle position data stored thereon for access by the user should the user be unable to remember where he or she parked the vehicle 10, and/or be unable to navigate his or her way back to the vehicle 10. To assist the user in locating the vehicle 10, the user need merely touch the vehicle smart key 20 to his or her smart device 30, or bring the vehicle smart key 20 within close proximity of the smart device 30, such that the transmitter 24 of the vehicle smart key 20 transmits the vehicle position data from the vehicle smart key 20 to the receiver 32 of the smart device 30 (see block 216 of FIG. 2).

With reference to block 218 of FIG. 2, the smart device 30 is configured to process the vehicle position data in order to display the location of the vehicle 10 on the display 34 of the smart device 30. For example, if the vehicle position data includes an Internet URL to a mapping website along with map coordinates identifying the location of the vehicle 10, the smart device 30 is configured to navigate to the mapping website and display the location of the vehicle 10 using maps of the mapping website, such as Google Maps. The smart device 30 is further configured to transmit the location of the smart device 30 (such as by using GPS capabilities of the smart device 30) to the Internet website in order to instruct the Internet mapping website to generate directions from the current location of the smart device 30 to the location of the vehicle 10 in order to assist the user with locating his or her vehicle 10.

The present teachings thus provide improved devices, systems, and methods for assisting a user with locating his or her vehicle, particularly when the vehicle is parked in a crowded parking lot and/or an area unfamiliar to the user.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A system for guiding a person to a vehicle comprising:
a vehicle control unit configured to generate vehicle position data identifying the vehicle's location and transmit the vehicle position data with a transmitter; and
a vehicle smart key including:
a smart key receiver configured to receive the vehicle position data transmitted by the vehicle control unit;
a smart key storage unit configured to store the vehicle position data; and
a smart key transmitter configured to transmit the vehicle position data to a smart device for display of the vehicle's location on the smart device.

2. The system of claim 1, wherein the vehicle position data includes map coordinates.

3. The system of claim 1, wherein the vehicle position data includes map coordinates derived from global positioning signals (GPS) received by a GPS receiver mounted to the vehicle.

4. The system of claim 1, wherein the vehicle control unit is configured to generate an Internet uniform resource locator (URL) including the vehicle position data.

5. The system of claim 4, wherein the URL further includes a link to an Internet mapping website and map coordinates.

6. The system of claim 1, wherein the vehicle control unit is configured to generate and store the vehicle position data at predetermined intervals.

7. The system of claim 1, wherein at vehicle shutdown the vehicle control unit is configured to transmit to the vehicle smart key the most recently generated vehicle position data.

8. The system of claim 1, wherein the control unit is a passive entry and passive start (PEPS) controller, and the smart key is a PEPS smart key.

9. The system of claim 1, wherein the smart key transmitter is a near field communication transmitter configured to transmit the vehicle position data to the smart device when the smart key is brought into contact with the smart device.

10. The system of claim 1, wherein the vehicle control unit is configured to generate the vehicle position data based on signals received from ground-based transmission towers.

11. The system of claim 1, wherein the vehicle control unit is configured to generate the vehicle position data based on signals received from a local area network (LAN) of the vehicle.

12. The system of claim 1, wherein the vehicle control unit is configured to generate the vehicle position data based on at least one of vehicle speed, vehicle heading, and vehicle steering information.

13. The system of claim 1, wherein the vehicle control unit includes a processor configured to generate the vehicle position data and a storage unit configured to store both the vehicle position data and instructions for generating the vehicle position data.

14. A system for guiding a person to a vehicle comprising:
a receiver;
a vehicle control unit configured to generate map coordinates corresponding the vehicle's location based on global positioning system (GPS) signals received from the receiver, and generate a uniform resource locator (URL) to an Internet mapping website that includes the map coordinates corresponding to the vehicle's location; and
a vehicle smart key configured to:
receive the URL transmitted from the vehicle control unit;
store the URL at the smart key; and
transmit the URL to a smart device;
wherein the URL directs the smart device to a map identifying the vehicle's location.

15. The system of claim 14, wherein in the absence of reliable GPS coordinates the control unit is configured to identify the vehicle's location based on signals received from ground-based transmitters.

16. The system of claim 14, wherein in the absence of reliable GPS coordinates the control unit is configured to identify the vehicle's location based on vehicle speed, heading, and steering information.

17. A method for guiding a person to a vehicle comprising:
generating vehicle location information corresponding to the vehicle's location using a vehicle control unit and storing the vehicle location information at the vehicle control unit;
generating at the vehicle control unit a uniform resource locator (URL) including map coordinates based on the vehicle location information, the map coordinates corresponding to the vehicle's location; and
transmitting the URL to a vehicle smart key at vehicle shut down;
wherein upon transmission of the URL to a smart device the smart device will display the vehicle's location and guide the person to the vehicle.

18. The method of claim 17, further comprising generating the vehicle location information and the URL based on GPS coordinates representing the vehicle's location.

19. The method of claim 17, further comprising generating the vehicle location information based on at least one of historical vehicle speeds and headings.

20. The method of claim 17, further comprising transmitting the URL from the smart key to the smart phone using near field communication.
